(19) United States
(12) Patent Application Publication
(10) Pub. No.: US 2006/0112214 A1
(43) Pub. Date: May 25, 2006

(54) Method for applying downgraded DRAM to an electronic device and the electronic device thereof

(76) Inventor: Tsuei-Chi Yeh, Hsinchu (TW)

Correspondence Address: MARTINE PENILLA & GENCARELLA, LLP, 710 LAKEWAY DRIVE, SUITE 200, SUNNYVALE, CA, 94085, US

(21) Appl. No.: 11/129,736

(22) Filed: May 13, 2005

(30) Foreign Application Priority Data
Nov. 24, 2004 (TW) 93136111

(51) Int. Cl. G06F 12/00

(52) U.S. Cl. 711/103

(57) ABSTRACT

An electronic device applying downgraded DRAM comprises a processing unit, a downgraded DRAM and a non-volatile memory. The processing unit is used for executing operations of the electronic device. The downgraded DRAM is provided for the processing unit to store program code and data temporarily, and the downgraded DRAM includes usable and unusable memory blocks. The non-volatile memory is used for storing a usable DRAM map that records the usable memory blocks of the downgraded DRAM, and the processing unit accesses the usable memory blocks of the downgraded DRAM according to the usable DRAM map. A method for applying downgraded DRAM to the electronic device is also disclosed, which can simplify the preprocessing of the downgraded DRAM and assembly procedure of the electronic device and thus reduces production cost.

### BACKGROUND OF THE INVENTION

a) Field of the Invention

The invention relates to a method for applying downgraded dynamic random access memory (DRAM) to an electronic device and the electronic device thereof, more particularly, a method that does not require presorting for applying downgraded DRAM to an electronic device and the electronic device thereof.

b) Description of Related Art

DRAM is an essential component in electronic devices. Its main purpose is for storing data or program code while the electronic device is in operation. In general, the size of DRAM affects operation performance; a bigger DRAM can store more data and program temporarily, thus less opportunity to read data or program from slower storage media such as flash memory or even disk. DRAM is mainly used in computer, communications and consumer electronics, for example, computers, printers, personal digital assistants (PDA), cellular telephones and such.

During manufacturing of DRAM, because of manufacturing defects, generation of some downgraded DRAM products is inevitable; for example, a 4M×16 DRAM could be downgraded to a 2M×16 DRAM due to defects in one half of the memory. Since most computer designs are performance driven, down graded DRAM cannot be applied either for the memory space discontinuity or out of spec working speed. Therefore, down graded DRAM is not used in most computer products. As a result, downgraded DRAM are scrapped or sold at a lower price. Nevertheless, for electronic devices such as consumer electronics that have lower requirement of performance, the acceptance of downgraded DRAM is feasible and can save material cost.

However, downgraded DRAM could have many configurations. Take 4M×16 DRAM as an example, if the DRAM is divided into 4 banks of 1M×16 each, then with one defect bank, the downgraded DRAM could be configured as 3M×16 which has 4 variations; or 2M×16 which has 6 variations; or 1M×16 which has 4 variations. Before applying downgraded DRAM to electronic devices production, system manufacturers must first presort such DRAM into different configurations. Furthermore, for the same electronic board to adopt different DRAM configurations, hardware jumpers are required in most applications. The aforementioned sorting and jumper usage, and the extra care for the manufacturing arrangement, all add cost to the whole products. In conclusion, an easier method of applying downgraded DRAM to electronic devices production will be valuable in cost reduction.

### SUMMARY OF THE INVENTION

In view of the aforementioned problem, an object of the invention is to provide a method for applying downgraded DRAM to an electronic device and the electronic device thereof, where the downgraded DRAM is able to be assembled directly to the electronic device for testing such that the presorting steps and the assembling procedure are simplified while the production cost is reduced.

To achieve the aforementioned object, the invention discloses an electronic device applying downgraded DRAM; the electronic device comprises a processing unit, a downgraded DRAM, and a non-volatile memory. The processing unit is used for executing operations of the electronic device. The downgraded DRAM is in signal connection with the processing unit and is provided for the processing unit to store program code and data temporarily; the downgraded DRAM includes usable and unusable memory blocks. The non-volatile memory is also in signal connection with the processing unit and is used for storing a usable DRAM map that records usable memory blocks of the downgraded DRAM, wherein the processing unit accesses the usable memory blocks of the downgraded DRAM according to the usable DRAM map.

The invention further discloses a method for applying the downgraded DRAM to the electronic device; the method includes a checking step, a testing step, and an accessing step. The checking step checks the memory for a usable DRAM map stored therein. The testing step tests for usable memory blocks in the downgraded DRAM and stores the usable memory blocks in the memory as the usable DRAM map. And the accessing step is for the processing unit to access the downgraded DRAM according to the usable DRAM map.

According to the method and electronic device of the invention, the cost incurred by the presorting steps can be cut because the downgraded DRAM is assembled directly to the electronic device for testing, and the saving of jumper or equivalent wiring of the assembling procedure of the electronic device further reduces the production cost.

### BRIEF DESCRIPTION OF THE DRAWINGS

FIG. 1 is a block diagram illustrating a preferred embodiment of an electronic device applying downgraded DRAM in accordance with the invention.

FIG. 2 is a flow diagram illustrating a preferred embodiment of a method for applying down graded DRAM to an electronic device in accordance with the invention.

### DETAILED DESCRIPTION OF THE INVENTION

Preferred embodiments of a method for applying downgraded DRAM to an electronic device and the electronic device thereof in accordance with the invention are described below with accompanying figures, where the same reference numerals refer to the same element through out the various figures.

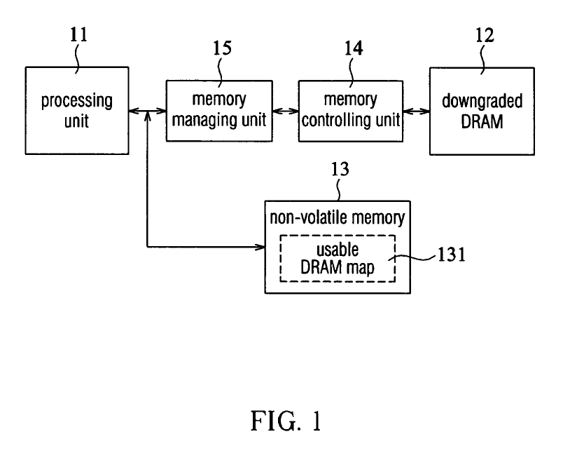

Referring to FIG. 1, a method for applying downgraded DRAM to electronic device and the electronic device thereof according to a preferred embodiment of the invention is an access event applied between processing unit and downgraded DRAM, in which the event is the reading and writing of data to the downgraded DRAM by the processing unit. The main structure of the electronic device applying downgraded DRAM is as shown in FIG. 1; the electronic device comprises a processing unit 11, a downgraded DRAM 12, and a non-volatile memory 13. The processing unit 11 is used for executing operations of the electronic device such as instruction execution and data computation. The downgraded DRAM 12 is in signal connection with the processing unit 11 and is provided for the processing unit 11 to store program code and data temporarily, and it has usable and unusable memory blocks due to manufacturing flaws. The downgraded DRAM 12 can be of conventional formats such as synchronous dynamic RAM (SDRAM), double date rate RAM (DDRAM), and DDR II SDRAM. The non-volatile memory 13 is also in signal connection with the processing unit 11 and is used for storing a usable DRAM map 131 that records the usable memory blocks of the downgraded DRAM 12. Thus, the processing unit 11 can access the usable memory blocks of the downgraded DRAM 12 according to the usable DRAM map 131 and avoid accessing the unusable memory blocks. The non-volatile memory 13 is capable of retaining related data of the usable DRAM map 131 with no power supplied, the non-volatile memory can be flash memory, electrically erasable programmable read only memory (EEPROM), ferro-electric RAM (FeRAM), or magnetoresistive RAM (MRAM), and so on.

Moreover, the electronic device applying downgraded DRAM also comprises a memory controlling unit 14 in signal connection between the processing unit 11 and the downgraded DRAM 12, and the memory controlling unit 14 can be integrated into the processing unit 11. The processing unit 11 accesses the downgraded DRAM 12 via the memory controlling unit 14. The electronic device may optionally applying downgraded DRAM further comprises a memory managing unit 15 that is in signal connection between the processing unit 11 and the memory controlling unit 14. The memory managing unit 15 transforms a logical memory address into a physical memory address for the memory controlling unit 14 to access the downgraded DRAM 12 according to the physical memory address. Hence, the processing unit 11 can access the downgraded DRAM 12 directly via the logical memory address to avoid accessing the unusable memory blocks of the downgraded DRAM 12. What is to be noted is that the memory managing unit 15 can be implemented in hardware and be integrated into the processing unit 12, or it can be implemented in software.

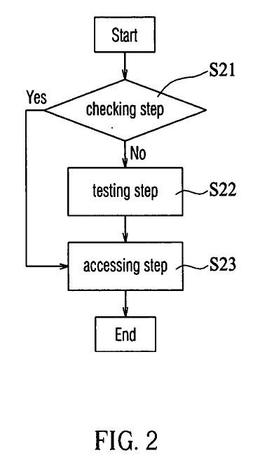

In describing a method for applying downgraded DRAM to an electronic device according to a preferred embodiment of the invention, the structure of the electric device is as shown in FIG. 1, and thus it is not further described here. It is to be noted that the downgraded DRAM 12 is assembled to the electronic device without undergoing the presorting steps. Referring to FIG. 2, a checking step S21 is executed when the electronic device is activated for the first time after it has been assembled; the checking step S21 is where the processing unit 11 checks the non-volatile memory 13 to determine whether the usable DRAM map 131 is stored therein. Since it is the first activation of the electronic device after its assembly, there is no usable DRAM map 131 stored in the non-volatile memory 13, and thus a testing step 22 is performed next. The testing step S22 is to test the downgraded DRAM 12, during which the usable memory blocks and unusable memory blocks are distinguished, and then the testing step stores the information of usable memory blocks in the non-volatile memory 13 as the usable DRAM map 131. Consequently, an accessing step S23 can be executed, during which the processing unit 11 performs read and write actions accurately to the downgraded DRAM 12 according to the usable memory block address recorded in the usable DRAM map 131.

As aforementioned, the non-volatile memory 13 is able to retain relative data of the usable DRAM map 131 with no power supplied. Therefore, when the electronic device is activated again, the checking step S21 would find that the usable DRAM map 131 exists in the non-volatile memory 13. Hence, the processing unit 11 can directly executes the accessing step S23 to access the downgraded DRAM 12 according to the usable memory block address recorded in the usable DRAM map 131 without performing the testing step S22.

According to the method for applying downgraded DRAM to an electronic device and the electronic device thereof of the invention, the downgraded DRAM is directly assembled to the electronic device without going through pre-sorting steps, and the testing of downgraded DRAM is done by each electronic device at first activation. Consequently, the cost incurred by pre-sorting steps is cut, and the simplification of the assembly of electronic devices further reduces the production cost as a whole.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An electronic device applying downgraded DRAM, comprising:
a processing unit for executing operations;
a downgraded DRAM in signal connection with the processing unit, the downgraded DRAM being provided for the processing unit to store program code and data temporarily and comprising usable memory blocks and unusable memory blocks; and
a non-volatile memory in signal connection with the processing unit for storing a usable DRAM map, wherein the usable DRAM map records the usable memory blocks of the downgraded DRAM, and the processing unit accesses the downgraded DRAM according to the usable DRAM map.

2. The electronic device applying downgraded DRAM as described in claim 1, wherein the non-volatile memory is flash memory, electrically erasable programmable read only memory (EEPROM), ferro electric RAM (FeRAM), or magnetoresistive RAM (MRAM).

3. The electronic device applying downgraded DRAM as described in claim 1, further comprising:
a memory controlling unit in signal connection between the processing unit and the downgraded DRAM, wherein the processing unit accesses the downgraded DRAM via the memory controlling unit.

4. The electronic device applying downgraded DRAM as described in claim 3, wherein the memory controlling unit is integrated into the processing unit.

5. The electronic device applying downgraded DRAM as described in claim 3, further comprising:
a memory managing unit in signal connection between the processing unit and the memory controlling unit, the memory managing unit transforming a logical memory address into a physical memory address for the memory controlling unit to access the downgraded DRAM.

6. The electronic device applying downgraded DRAM as described in claim 5, wherein the memory managing unit is integrated into the processing unit.

7. The electronic device applying downgraded DRAM as described in claim 5, wherein the memory managing unit is implemented by software.

8. The electronic device applying downgraded DRAM as described in claim 1, wherein the downgraded DRAM is synchronous DRAM (SDRAM), double date rate SDRAM (DDR SDRAM), or DDR II SDRAM.

9. A method for applying downgraded DRAM to an electronic device, the electronic device comprising a processing unit and a memory, the method comprising the steps of:
checking whether a usable DRAM map is stored in the non-volatile memory;
testing for usable memory blocks of the downgraded DRAM, and storing the information of usable memory blocks as the usable DRAM map in the non-volatile memory; and
accessing the downgraded DRAM according to the usable DRAM map by the processing unit.

10. The method for applying downgraded DRAM to an electronic device as described in claim 9, wherein the checking step is performed when the electronic device is first activated after assembly.

11. The method for applying downgraded DRAM to an electronic device as described in claim 9, wherein the testing step is performed when the non-volatile memory does not have the usable DRAM map stored therein.

12. The method for applying downgraded DRAM to an electronic device as described in claim 9, wherein the accessing step is performed directly if the memory already has the usable DRAM map stored therein.

13. The method for applying downgraded DRAM to an electronic device as described in claim 12, wherein the non-volatile memory is flash memory, EEPROM, FeRAM, or MRAM.

14. The method for applying downgraded DRAM to an electronic device as described in claim 9, wherein the processing unit accesses the downgraded DRAM via a memory controlling unit.

15. The method for applying downgraded DRAM to an electronic device as described in claim 14, wherein the memory controlling unit is integrated into the processing unit.

16. The method for applying downgraded DRAM to an electronic device as described in claim 14, wherein the processing unit uses the memory controlling unit to access the downgraded DRAM after a memory managing unit has transformed a logical memory address into a physical memory address.

17. The method for applying downgraded DRAM to an electronic device as described in claim 16, wherein the memory managing unit is integrated into the processing unit.

18. The method for applying downgraded DRAM to an electronic device as described in claim 16, wherein the memory managing unit is implemented by software.

19. The method for applying downgraded DRAM to an electronic device as described in claim 9, wherein the downgraded DRAM is SDRAM, DDR SDRAM, or DDR II SDRAM.
